(19) United States
(12) Patent Application Publication
(10) Pub. No.: US 2008/0287638 A1
(43) Pub. Date: Nov. 20, 2008

(54) Supramolecular Polymers Associative to Carbon Nanotubes

(76) Inventors: John R. Reynolds, Gainesville, FL (US); Ryan M. Walczak, Gainesville, FL (US); Eveline Maria van der Aa, Gainesville, FL (US); Andrew Gabriel Rinzler, Newberry, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/123,347

(22) Filed: May 19, 2008

Related U.S. Application Data
(60) Provisional application No. 60/938,588, filed on May 17, 2007.

(51) Int. Cl. C08G 18/10

(52) U.S. Cl. 528/59

(57) ABSTRACT

A supramolecular polymer and its composite with carbon nanotubes, CNTs, are described. The supramolecular polymer is an ensemble of precursors that independently contain “sticky feet” for non-covalent binding to carbon nanotube surfaces and associative groups. There is at least one of the associative groups covalently bound to each of the precursor and there is at least one covalently connecting moiety connecting associative groups within a precursor or connecting an associative group to a linker to a “sticky foot” in a precursor. When the associative groups are in a dissociative state, the supramolecular polymer precursors and CNTs can be combined to form a dispersion. Upon promotion, the dissociated associative groups in the dispersion can associate to yield a CNT/supramolecular polymer composite.

### CROSS-REFERENCE TO RELATED APPLICATION

The present application claims the benefit of U.S. Provisional Application Ser. No. 60/938,588, filed May 17, 2007, which is hereby incorporated by reference herein in its entirety, including any figures, tables, or drawings.

### FIELD OF THE INVENTION

The invention relates to molecules containing groups for association to each other to form a supramolecular structure and containing groups for association with carbon nanotubes to form well dispersed self-healing composites.

### BACKGROUND

Polymeric materials which incorporate carbon nanotubes (CNT) are a new class of materials whose promise includes high tensile strength and modulus, high thermal stability, greater toughness, electrical conductivity, enhanced thermal conductivity, and tunability of mechanical properties, such as elasticity, as a function of nanotube loading. There still exist a number of significant problems associated with CNT based polymer composites (see for example Moniruzzaman, M. et al. Macromolecules 2006, 39, 5194-5205). These problems stem from two intrinsic properties of the nanotubes: 1) they possess a well passivated, low energy surface which means that their bonding with other materials is predominantly via weak van der Waals bonds and 2) they bond exceptionally well to each other, thus being found predominantly in bundles and agglomerated bundles. The nanotube-nanotube bonding is also via van der Waals forces however such forces are greater between atoms of the same type and rise quickly with proximity of the atoms involved. Particularly close proximity of inter-nanotube atoms is guaranteed by the nanotube atomic scale flatness, their ability to come into atomic registry with each other over long distances, and their flexibility. Incorporating CNTs into a polymer is accomplished through either solution or melt blending processes. Both of these techniques are problematic. Solution blending requires the suspension and debundling of CNTs via ultrasonication followed by the addition of polymer and precipitation or film casting. This solution blending process tends to produce inhomogeneous composites due to agglomerated nanotubes within the polymer matrix. Composites made in this manner also typically contain extraneous material needed to suspend the nanotubes in the original solution. Melt blending is a process that uses high temperatures and high shear forces to disperse the nanotubes in the polymer. Here, nanotube agglomeration remains a problem and loading of the nanotubes in the polymer matrix is severely limited due to a resulting high intrinsic viscosity of the composites even at low nanotube concentrations. Melt blending can not generally be used with thermoset polymers.

CNTs can be partially debundled and prepared as stable or metastable suspensions using a variety of techniques such as: the use of surfactant molecules; complexing agents such as metalloporphyrins (see for example Stoddart, J. F. et al. Small 2005, 1(4), 452-461), DNA, or other polymeric materials, usually with application of ultrasonication and or high shear mixing. Alternatively, spontaneous debundling of lithiated CNTs along with their charge stabilized suspension in ammonia was demonstrated by Penicaud, A. et al. J. Am. Chem. Soc. 2005, 127(1), 8-9). The materials used to suspend the nanotubes often interfere with the processing of the nanotube composites, either due to the large quantities of suspending agent (e.g. with TRITON-X™ surfactant) used or to the stringent conditions necessary to handle the dispersed nanotubes (e.g. the lithiated nanotubes, which must be processed in liquid ammonia or other toxic solvents, under extremely dry conditions). Generally, although preferable to composite preparation without a processing aid, forming CNT composites with such processing aids comes at the expense of leaving the suspending agent in the composite as an impurity or dealing with harsh conditions that complicate the process and limits the types of polymer usable for the composite.

Even successfully prepared CNT composites display problems. For example, when a CNT/polymer composite is subjected to a stress, the vastly different elastic moduli of the nanotubes versus the polymer matrix can cause micro-tears in the polymer, thereby weakening the composite. Since the extremely rigid CNTs do not conform under stress along with the polymer, the CNTs essentially “pokes holes” in the polymer matrix by delamination of the polymer from the CNT surface (nanotubes pull out of the surrounding polymer). The intrinsically weak interactions between common polymers and the CNT sidewalls lead to stress, creep, and shear, that act to tear the polymer from the nanotube surface, thus compromising the desired properties of the composite. This effect is analogous to fiber pull-out that is well known on the macro-scale for fiber reinforced composite materials.

Recent applications from common inventors to this application, PCT/2007/081121 and PCT/US2008/054372 disclosed that “sticky” polymers and “sticky” dopant molecules have the potential to alter significantly the properties of SWNT films and composites derived therefrom. These polymers self-assemble onto the nanotube sidewalls through non-covalent interactions but do not appreciably alter the mechanical properties of the CNTs, and in the case of “sticky” polymers do not appreciably alter the electronic properties of the CNTs. These polymers form a multiplicity of non-covalent interactions of specific pendant groups covalently linked to a conjugated or non-conjugated polymer chain that allow for a permanent, thermodynamically stable attractive interaction between the nanotube and the polymer. An extremely high binding constant occurs due to a multiplicity of the polymer's “sticky” pendant groups associating with the CNT. The solubility of the nanotube/sticky polymer hybrid is dictated by that of the polymer which can be tailored as desired, by incorporation of solublizing pendant and functional groups on the sticky polymer, thereby greatly reducing nanotube agglomeration. Moreover, the sticky polymer can be tailored to interact strongly with the major polymeric constituent of the ultimate composite yielding a more homogeneous blend of the modified CNTs and the major polymeric constituent. Although this approach effectively solves the problem of constructing strong interfaces between the CNT sidewall and the polymer matrix, it does not solve other problems of CNT-polymer composites such as the propensity of polymers to form micro-fractures and cracks under stress and wear.

Supramolecular polymers, as defined in Brunsveld, L. et al. Chem. Rev. 2001, 101, 4071-40970, are “ . . . polymeric arrays of monomeric units that are brought together by reversible and highly directional secondary interactions, resulting in polymeric properties in dilute and concentrated solutions, as well as in the bulk. The monomeric units of the supramolecular polymers themselves do not possess a repetition of chemical fragments. The directionality and strength of the supramolecular bonding are important features of systems that can be regarded as polymers and that behave according to well-established theories of polymer physics.” Hence, a supramolecular polymer is constructed of short small-molecule or oligomeric segments which contain at least two functional groups that by non-covalent association, form high molecular weight polymeric materials. Supramolecular polymers use non-covalent associative groups, whose binding constants are preferentially appreciably high (e.g. K>10⁵), to form highly stable polymeric backbones that can display high molecular weights in solution, as well as in bulk. Viscometric measurements have indicated molecular weights for these polymers that exceed 1,000,000 g/mol.

These polymers differ from conventional polymers due to their dynamic nature. Supramolecular polymers exist as a statistical distribution of associated and non-associated chain ends in the material where the proportions of these two states depend predominately on the thermodynamic equilibrium of the association process. At sufficiently low temperatures, where there is insufficient energy to exceed the activation barrier for the association-dissociation process, or below a glass transition temperature of the supramolecular polymer, the system lies in a meta-stable equilibrium. At sufficiently elevated temperatures, the composition can be considered in a state of a dynamic equilibrium between the associated and non-associated states. At some critical temperature, T_{c}, the entropically-driven kinetic driving force for dissociation overcomes the non-covalent bond enthalpy, and the polymer is essentially dissociated into its monomeric or oligomeric constituents which manifests, in most systems, as a sharp drop in viscosity. This same association/disassociation can be driven by concentration of the associative groups in a solvent that solvates both the monomer and the polymer.

Supramolecular polymers show potential for use in a variety of applications, including thermoplastics, elastomers and adhesives. One unusual property that can be displayed by supramolecular polymers is the ability to undergo “self-healing” by annealing. Since the supramolecular polymer backbone includes thermally reversibly linked repeat units, generalized or localized heating allows fractures and cracks in the polymer matrix to be repaired due to the reorganization of the supramolecular assembly via the equilibrium between the associated and non-associated states. For this reason the supramolecular polymers are more easily processed, molded, and otherwise manipulated with methods used for high molecular weight covalent polymeric materials. By the addition of an appropriate solvent, supramolecular polymers can be “switched” between their essentially polymeric and essentially monomeric forms. Where the supramolecular assembly is formed by hydrogen bonding interactions, the acidity of the solution as well as the dielectric constant of the solvent can effectively alter the extent of association. The supramolecular association/dissociation can also be achieved through reversible covalent bonds, such as Diels-Alder adducts (e.g. as disclosed by Chen et al. Science 2002, 295, 1698-1702).

Relatively small molecules with “sticky” substituents to bind with CNTs combined with units for self or complementary association to form supramolecular polymers are not known. Such systems would be promising for the dispersion of CNTs into a matrix that upon cooling or removal of a solvent form a stable composite that will undergo healing during or after a mechanical of thermal stress to avoid or repair defects generated by stress.

### SUMMARY OF THE INVENTION

The invention is directed to a “sticky” supramolecular polymer that has a multiplicity of associated precursors that in combination have a multiplicity of sticky feet attached to at least some of the precursors through linkers and a multiplicity of associative groups with at least one group covalently bound to each precursor, which have at least one covalently connecting moiety connecting the associative groups to each other or to the linker in a given precursors. The sticky feet are structures that can bind non-covalently to a CNT surface. In one embodiment of the invention the associative groups self-associate where two or more of the associative groups from two or more precursors combine to form the supramolecular polymer. In another embodiment, the associative groups have complementary structures that cross-associate such that two or more groups can associate to form the supramolecular polymer. The association is sufficiently strong to maintain an associated supramolecular polymer by the combination of many associations, but where individual associations are reversible, for example, the association can be thermally reversible. Although association can be by the formation of a reversible covalent bond, generally, the association is not by covalent bonding. For example, the associative groups can associate via hydrogen-bonding. The association can require an agent in addition to the precursors, such as a complexing agent. In one embodiment the complexing agent can be a metal ion and the associative groups are bidentate or polydentate ligands that can simultaneously complex to the metal ion.

The sticky feet are moieties that can independently form non-covalent interactions with CNT surfaces. In general, the sticky feet are structures that can form donor-acceptor complexes with CNT surfaces. The backbone connecting moieties of the supermolecular polymer precursors can be oligomers or polymers that contain conjugated or non-conjugated repeating or both. The linker attaching the sticky feet and precursors can be a flexible chain of 1 to 100 atoms or more, for example 101 to 2000 atoms. Additionally, the polymer can contain functionalities of the precursors to modify the surface or bulk properties of the supramolecular polymer. Such functionalities can undergo irreversible reactions with each other or with additional reagents complementary to the functionalities.

From the supramolecular polymers summarized above, a CNT/supramolecular polymer composite can be formed from a multiplicity of CNTs and a multiplicity of associated precursors that in combination have a multiplicity of sticky feet bound to CNTs where the sticky feet are attached to at least some of the precursors through linkers. The composite can also include a multiplicity of functionalities that modify bulk or surface properties of the composite. The composite can also contain a multiplicity of irreversible cross-linking sites wherein the composite can be fixed as an irreversible network upon promoting irreversible cross-linking of these sites.

The CNT/supramolecular polymer composite can be formed by providing a multiplicity of CNTs and a multiplicity of dissociated precursors as those summarized above, dispersing the CNTs into the dissociated precursor, and subsequently associating the dissociated precursor molecules bound to the dispersed CNTs to yield the CNT/supramolecular polymer composite. Dispersing the CNTs and precursors can involve mixing the CNTs with the precursors at a temperature greater than a critical temperature T_{c} for association of the groups. In such an embodiment the composite is fixed by the association that occurs upon cooling the mixture below the T_{c}. In an alternate embodiment, dispersing can occur by mixing the CNTs with the precursors in a solvent that disrupts association of the groups and removing the solvent results in the association to form the composite. In another embodiment, dispersing can occur by mixing a dispersion of CNTs in a solvent with the precursors dissolved in a solvent that does not disrupt the association of the groups. In another embodiment, dispersing can be carried out by mixing the CNTs with the precursors where the associative groups are bound to at least one protecting group allowing association to the composite when the protecting groups are removed. In another embodiment, dispersion is achieved by mixing the CNTs with the precursors where the associative groups require a complexing agent to undergo association but the agent is absent until binding to the CNTs is achieved and the complexing agent is added to allow the association that forms the supramolecular polymer and fixes the composite.

The method of forming the CNT/supramolecular composite can also include steps for providing functionality capable of undergoing irreversible reactions that are attached to at least some of the precursors and a step to promote the irreversible reactions to form cross-linking sites after a desired composite structure is achieved by the associative-dissociative equilibria possible in the composite before fixing the structure by the irreversible cross-linking. The functionality can require a complementary reactive group that is monomeric, oligomeric or polymeric where the cross-linking sites contain residues from the functionalities and the complementary reactive groups.

### BRIEF DESCRIPTION OF THE FIGURES

FIG. 1 is a schematic drawing of one embodiment of the invention showing a sticky supramolecular polymer and its precursor containing only a single sticky foot and two self-associating end groups.

FIG. 2 shows a supramolecular polymer of one embodiment of the invention where a connective moiety, a linker, a sticky foot, and two self-complementary associative groups per precursor form a supramolecular polymer via hydrogen bonding of the associative groups.

FIG. 3 shows a supramolecular polymer of one embodiment of the invention where there are precursors with a backbone and 2 or 3 associative groups and another precursor with a single sticky foot and linker and a single associative group where the supramolecular structure results from hydrogen bonding with 4 hydrogen bonds formed between pairs of associative groups and where some precursors can only form 3 hydrogen bonds by the self-association of groups but form 4 hydrogen bonds via cross-association with complementary groups.

FIG. 4 shows the synthesis of a supramolecular polymer precursor of one embodiment of the invention where there are two pyrene sticky feet and linkers attached to two urea associative groups where the supramolecular structure results from hydrogen bonding between urea units.

### DESCRIPTION OF THE INVENTION

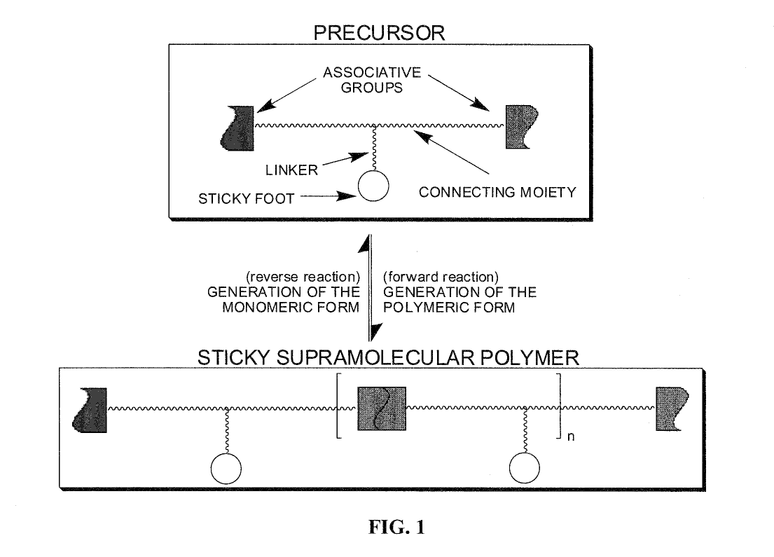

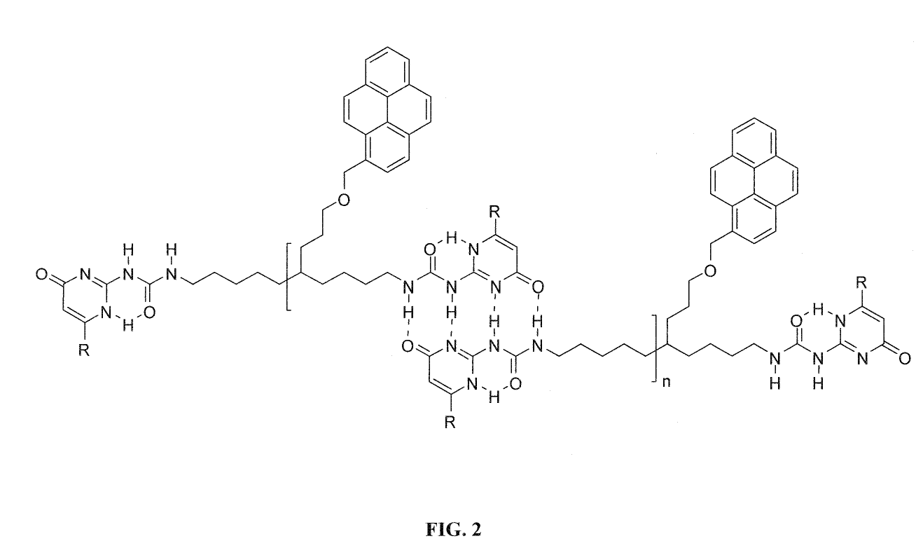

The invention is directed to the formation of a composite of carbon nanotubes in a sticky supramolecular polymer matrix, the sticky supramolecular polymers, and the precursors to prepare the supramolecular polymer. One embodiment of the sticky supramolecular polymer is illustrated in FIG. 1. In FIG. 1 a single precursor comprises a backbone, or connecting moiety, which is a non-conjugated short-chain oligomeric material (such as oligomethylene or oligoethoxy) or a conjugated and/or electroactive segment (such as thienyl, fluorenyl, oligothienyl, or oligofluorenyl), functionalized with a single sticky foot by a linking group and two end-groups capable of self-association whose association results in the supramolecular polymer. A specific embodiment is shown in FIG. 2 where the sticky foot is a pyrene moiety attached via a 4 carbon ether linker to a 10 carbon backbone connecting two ureidopyrimidinone associative groups. The supramolecular polymers of the present invention can be essentially linear polymers, branched polymers, or networks. The supramolecular polymers can be constructed from a single precursor, two complementary precursors, or many different precursors as long as the associative groups permit the formation of an effective solid at least in the absence of a solvent at ambient conditions, and where the number of sticky feet are sufficient to provide a multiplicity of interactions with individual CNTs per supramolecular polymer. In general, at least 5 sticky feet per supramolecular polymer are needed for stable interaction with the CNTs. The design requirements, and the how one can design for the total system given the nature of the sticky feet and other parameters, is given in U.S. Prov. Appl. PCT/US2008/054372, which is incorporated by reference herein. CNTs can be single wall nanotubes (SWNTs) or multiwall nanotubes (MWNTs), or mixtures thereof.

Electroactive segments as used herein can be defined as: a polymer or oligomer segment whose electronic and/or optical properties can be measurably modified by application of an electric field; a polymeric or oligomeric segment that is redox active; a polymeric or oligomeric segment that is electrically conducting or semiconducting; a polymer or oligomers segment that undergoes electron and/or hole transport; and/or a polymer or oligomer segment that can form charge carriers upon the application of a stimulus such as photoexcitation. The coupling of electroactive supramolecular polymers with CNTs permits fabrication of a variety of devices using the unusual processing possibilities of CNT/supramolecular polymer composites.

The groups for association into the supramolecular polymer need not be self-complementary as in the embodiment that is illustrated in FIG. 1. In other embodiments of the invention the groups can exist in cross-complementary forms, or as self- or cross-complementary groups that require an associating agent. For example, in one embodiment a metal ion can be included as an agent to associate with two or more bidentate or polydentate ligands attached to the precursor, where the association is the metal complex that forms to yield the supramolecular polymer. The association need not be limited to non-covalent interactions as is common of traditionally defined supramolecular polymers. Rather, in one embodiment of the invention, the precursor can contain any complementary end-groups that can reversibly form at least one covalent bond, for example cross-complementary groups which can reversibly undergo Diels-Alder cycloaddition. The associating groups can also exist in the precursor in a protected form such that they can not associate until deprotection has occurred. For example, in one embodiment where the association that forms the supramolecular polymer is hydrogen bonding, some to all amino, amido, or hydroxy groups of the precursor can be protected with trialkylsilyl groups that can be exchanged with protons by a variety of known reaction methods to yield associating groups and the resulting supramolecular polymer upon deprotection.

In some embodiments of the invention, the associative groups that rely on hydrogen bonding can have four or more hydrogen bonds per associative unit, however, as some to all the precursors can have more than two associative groups and can have one or more sticky feet within the precursor, the combined associative/dissociative equilibria for multiple groups coupled with the CNT/sticky feet equilibria permits associative group with three or fewer hydrogen bonds to result in a sufficiently high composite equilibrium constants between precursors such that a stable composite results. In some embodiments of the invention, the hydrogen bonding associative groups can have groups that have unequal amounts of hydrogen bond donors and hydrogen bond acceptors, for example urea groups can be used which have two hydrogen bond donors and one hydrogen bond acceptors per associative group. In like manner, associative groups for non-hydrogen bonding systems can have relatively small association/dissociation equilibrium constants (below 10⁵); yet by combination of multiple associations, or in combination with sticky feet/CNT interactions, permit the formation of a stable CNT/supramolecular polymer complex.

Associative groups that can be used for one or more embodiment of the invention include: ureidopyrimidinones and other groups that can undergo homo- or hetero-complexation via complementary H-bonding motifs; calix[4]arenes, which can associate via the complexation with C₆₀; carboxylic acids; the carboxylic acid/amino interaction; nucleotides; oligonucleotides; peptides; peptide nucleic acids; multidentate organometallic complexes, such as terpryrdyl (which can associate with metals such as Ruthenium) or nitrilotriacetate groups (which can associate with metals such as Nickel); groups such as perylene-bis(imides), which form discotic liquid crystalline phases; polycyclic aromatic hydrocarbons which can associate via van der Waals interactions; dendrimers or dendrons (such as those described in Versteen et al. J. Am. Chem. Soc. 2005, 127, 13862-13868); phthalhydrazide derivatives, which can form cyclic trimers; sulfides, which can form covalent disulfide main chain polymers; and thermally reversible Diels-Alder adducts, which can form covalent main-chain polymers. Other groups can be used as long as the equilibrium constant for that group or combination of complementary groups is sufficiently high for the number of sticky feet and associative groups that are contained in the average precursor.

The sticky feet are limited to groups that do not form a covalent bond to the CNT such that the bond order of the nanotubes is not modified by such bonds. The sticky foot can be any moiety, individually or in combination, described in PCT/US2007/081121, which is incorporated by reference herein, capable of undergoing a non-covalent interaction with a CNT surface by van der Waals interactions or undergoing a charge transfer doping as described in U.S. Prov. Appl. 60/890,704, attached herewith as “Appendix 2”. In various embodiments of the invention, the sticky supramolecular polymer can include multiple precursors with different sticky feet or a single precursor with two or more sticky feet.

The backbone, the connecting moiety between associative groups can be non-conjugated or conjugated chains depending upon the intended use of the CNT/supramolecular polymer composites. Among conjugated chains that can be used are polymers and oligomers of polythiophene, polypyrrole, polydioxythiophene, polydioxypyrrole, polyfluorene, polycarbazole, polyfuran, polydioxyfuran, polyacetylene, poly(phenylene), poly(phenylene-vinylene), polyaniline, polypyridine, and polyfluorene. Homopolymer and various copolymer structures can be used, including non-conjugated units.

Among non-conjugated backbones, which act as the connecting moieties, the backbones can be prepared by any step growth or chain growth polymerization technique. Inclusive in the step growth polymers that can be used in the practice of the invention are polyesters, polyamides, polyurethanes, polyureas, polycarbonates, polyaryletherketones, and polyarylsulfones. Inclusive with the chain growth polymers are polyolefins, polyacrylates, polymethacrylates, polystyrenes, polyacrylamides, polyalkadienes, and polyvinylethers. Non-organic backbones such as polysiloxanes can be used in the practice of the invention. Natural polymers such as polypeptides and polysaccharides can be modified or polymerized artificially to include dopant moieties. Among conjugated polymers that can be used for the practice of the invention are polyfluorene, poly(p-phenylene), PPV, polythiophene, polydioxythiophene, polypyrrole, polydioxypyrrole, polyfuran, polydioxyfuran, polyacetylene, and polycarbazole. The architecture of the backbone can be linear, branched, hyperbranched, star-shaped and dendritic.

In some embodiments of the invention, some or all of the precursors can contain at least one additional functionality such as an alcohol, ester, and olefin, which can be directly bonded to the backbone or via a linker. The additional functionalities can be contained on a precursor that contains at least one sticky foot or at least one associative group. These functionalities can be incorporated to modify the bulk or surface properties of the final CNT/supramolecular polymer composite. These functionalities can also be used to form irreversible covalent bonds between precursors after the incorporation of CNTs. In this manner, multiple precursors can be coupled into larger precursors after introduction of the CNTs and, in the limit, all precursors can be combined via cross-linking sites into an irreversible elastomeric or rigid thermoset polymeric network upon addition of one or more complementary reagents and/or an initiator to promote reaction between the functionalities. The complementary reagent can be monomeric, oligomeric or polymeric in nature. When oligomeric or polymeric, the complementary reagent can be a precursor containing one or more sticky feet and/or associative groups. When a covalently cross-linked network is formed from the reactions of the additional functionalities, some or all of the self-healing nature of the CNT/supramolecular composite can be retained. The reversibility of the supramolecular polymer can also enhance the efficiency of the cross-linking process as isolated functionality that would be otherwise inaccessible can become accessible via the association/dissociation equilibria of the associative groups.

The sticky feet that non-covalently bind with the sidewall of CNTs include, but are not limited to, pyrene, phenanthrene, anthracene, pentacene, porphyrin, carbazole and ferrocene. Sticky feet can also associate with the CNTs by a charge transfer doping, which can be either p-type or n-type dopants. For p-type dopants, tetracyanoquinodimethane (TCNQ) derived feet, can be used to achieve individual charge transfer interaction where the TCNQ unit extracts electrons from the nanotube. Other known p-type dopant can be modified to be linked to a polymer chain. These include derivatized TCNQs (e.g. halogenated-TCNQs), 1,1-dicyanovinylenes, 1,1,2-tricyanovinylenes, benzoquinones, pentafluorophenol, dicyanofluorenone, cyano-fluoroalkylsulfonyl-fluorenones, pyridines, pyrazines, triazines, tetrazines, pyridopyrazines, benzothiadiazoles, heterocyclic thiadiazoles, porphyrins, phthalocyanines, and electron accepting organometallic complexes. An n-type dopant foot that can be used is derived from tetrathiafulvalene (TTF) or its closely related analogue bis-ethylenedithiol-TTF (BEDT-TTF) where these n-type feet donate electrons to the nanotube. Other known n-type dopants that can be modified to be used as donor feet in the compositions and methods of this invention include amines and polyamines, other functionalized TTF derivatives, tetraselenafulvalenes (often used in organic superconductors), fused heterocycles, heterocyclic oligomers, and electron donating organometallic complexes.

In one embodiment the sticky foot can include a protecting group such that it can be converted to the moiety that sticks to a CNT surface upon deprotection. In one such embodiment the sticky supramolecular polymer contains multiple repeat units including one unit that has a sticky dopant to p-dope a CNT and a second repeat unit functionalized with a protected n-doping sticky dopant that upon removal of the protecting group in situ, the n-doping sticky dopant can undergo charge transfer with the p-doped CNT, yielding a strong sticky supramolecular polymer/CNT association.

The linker used to connect the sticky foot to the backbone is usually constructed of a flexible alkyl chain, but can be of other compositions including, but are not limited to, ether chains, and cyclic linking groups. The linker can also be conjugated and can include, but is not limited to vinylene, ethynylene, phenylene, and combinations thereof. The linkers can contain heteroatoms, such as S, N, O, and Si. Linkers can have a length of 1 to 100 atoms or more, generally being 2-20 carbon atoms long.

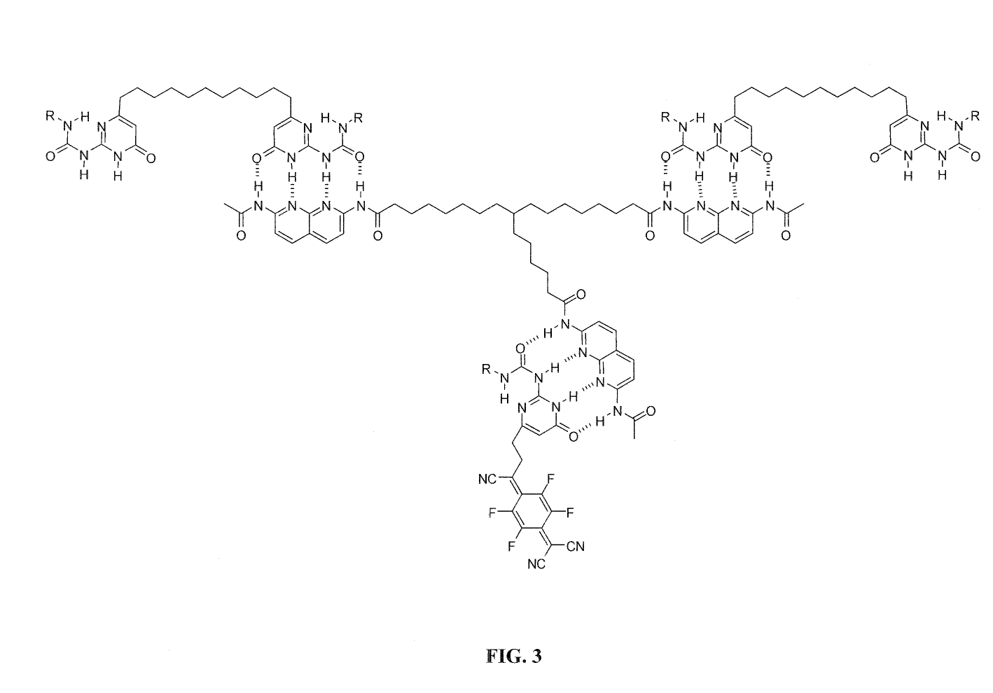

The number of sticky feet in a supramolecular polymer precursor can range from 0 to about 20 or more, however a significant portion of the precursors contain at least 1 sticky foot. In an embodiment of the invention, a portion of the precursors contains no sticky feet. In general the proportion of precursors without at least one sticky foot is less than about 95%. The number of associative groups on a given precursor can range from 1 to about 10 or more; however the average number of associative groups per precursor is about 2 or more to assure that a sufficiently large supramolecular polymer is formed. When the average number of associative groups per precursor exceeds 2, the supramolecular polymer can be a gel before the inclusion of the CNT at temperatures below T_{c}. In one embodiment, a single sticky foot and a single associative group can be contained on a single precursor and all other precursors can have no sticky feet, as shown in FIG. 3. FIG. 3 also illustrates cross-complementary association by 4 hydrogen bonds where precursors containing 3 associative groups can not form 4 hydrogen bond self-associations.

The invention is also directed to the CNT/supramolecular polymer composites that are formed by the dispersion of the CNT in the supramolecular polymer. In general, the composites have no or only a low degree of aggregation of the CNTs, however, varying degrees of aggregation are possible within the scope of the invention. In many embodiments of the present invention, composites display a degree of CNT loading such that an electrical percolation threshold is achieved. In this manner two or more surfaces of the composite can be attached to two or more connecting structure to exploit features of CNTs such as their electrical and thermal conductivities. Other properties, such as mechanical reinforcement, do not require that the proportion of CNT is sufficiently high to meet or exceed the percolation threshold and nearly any proportion of CNTs to supramolecular polymer can be used as long as the number of sticky feet per supramolecular polymer is sufficient to form a stable association with a given CNT as described above.

Composites according to the present invention generally display self-healing properties. The supramolecular polymers have reversible associations that form the polymer. The rate of the exchange of the associative groups will vary based on the nature of the composite. Factors affecting the exchange include the binding strength of the association, the mobility of the chains, links or backbones connected to the groups, local stresses in the vicinity of the association, etc. For example, generally little or no exchange can occur in a matrix at temperatures below the supramolecular polymer's glass transition temperature, regardless of the energy barrier for the association-disassociation reaction of the associative groups, but exchange can be rapid in a matrix that would be a liquid if not for the network formed by connectivity of the associated complementary groups and the sticky feet binding the nanotubes. In the non-exchanging regime, self-healing would generally be insignificant while in a rapidly exchanging regime one may not ever observe a wound to be healed as the exchange immediately repairs any damage that results to the matrix. The nature of the healing mechanism is that at sufficient thermal energy the matrix rearranges constantly until a minimum energy structure is achieved. For any composite where healing is not observed, generally heating the composite to a sufficient temperature will result in healing as long as a decomposition process does not occur at a lower temperature.

The association-disassociation mechanism of healing can also be exploited while using CNT/supramolecular composites to fabricating devices. For example, blocks, rods, spheres or any other shapes of the composites can be placed in intimate proximity to each other and heated at the interface or to the entire structure at a temperature where the equilibrium occurs and results in surface bonding but at a temperature insufficient to coalesce individual shapes, yielding a continuous complex structure. Specific coatings can be applied to the surface of the composite where the coating is not miscible with the composite, but contains a sufficient number of associative groups of like structure or structures to that of the supramolecular polymer such that it bonds to the surface of the composite by associating with associative groups of the supramolecular polymer. Again, the reversible exchange will permit optimization of the bonding.

The CNT/supramolecular composites can be prepared by dispersing the CNTs into the supramolecular polymer in the disassociated form by any dispersing techniques known for the practice of the art of composite formation and appropriate for use with CNTs. The supramolecular polymer can be dissociated by heating or by exposing to a solvent or disassociating agent. In this manner, the aggregated CNTs can be dispersed as small aggregates or isolated nanotubes. Heating can be ceased or the solvent or dissociating agent removed when the desired state of CNT dispersion is achieved. The associative groups can be protected by a group that is covalently bonded to the associative group, permitting the CNTs to be dispersed while the protecting group is present and subsequently removed to fix the composite upon association of the deprotected associative groups. Alternately, the association can be one that requires the associative groups of the precursor and an additional complexing species, for example where the associative groups are bi- or polydentate ligands and the complexing species is a metal ion, which can be added after the CNTs have been dispersed in the precursor and the composite fixed by addition of the complexing species.

The suspension of the CNTs in the dissociated supramolecular polymer can be molded, cast as a film, or sprayed, where dissociation is carried out by heating or due to the presence of a solvent, or both, where a solution of the CNT/supramolecular polymer composite is heated. The self-healing properties, as described above, permit novel methods of using the composites. Particles, molded structures, or other solid forms can be further processed into complicated forms due to the associative/dissociative equilibrium permitting the formation of connections between solid parts. For example relatively small cylinders of the CNT/supramolecular polymer composites can be joined at their ends with heating to form a long cylinder or wire. Solid structures or liquids of the CNT/supramolecular polymer composites can be combined with other materials which have complementary associative groups to those of the supramolecular polymer to permit higher order composites, laminates and coated structures.

A wide variety of improved products are possible by composite materials according to the present invention. Exemplary products include: organic light emitting diodes and displays (OLEDs); photovoltaic or solar cells; electrochromic devices and displays; field effect transistors; supercapacitors, electrochemical capacitors, and dielectric capacitors; and both primary and secondary batteries. Compositions according to the present invention can have significant applications for use with biological systems, such as electrode materials that are currently being used in contact with biological systems as bio-sensors, bio-detectors, drug and other active molecule release agents, and electrical charge stimulating devices, such as neural network electrodes. The interface between the conductive electrode and the biological system is generally the crucial point for exchange of information and for biocompatibility. Polymer coatings provide one means in which to provide an enhanced and more stable interfacial interaction. The sticky polymer CNT materials according to the present invention can provide an excellent alternative to materials currently used in this field. In addition to the pendant binding group, these polymers can have groups, such as oligooxyethylene, to provide biocompatibility and cell adhesion, while also containing groups that provide specific interactions with the bio-system (such as DNA complements for bio-sensors).

### Materials and Methods

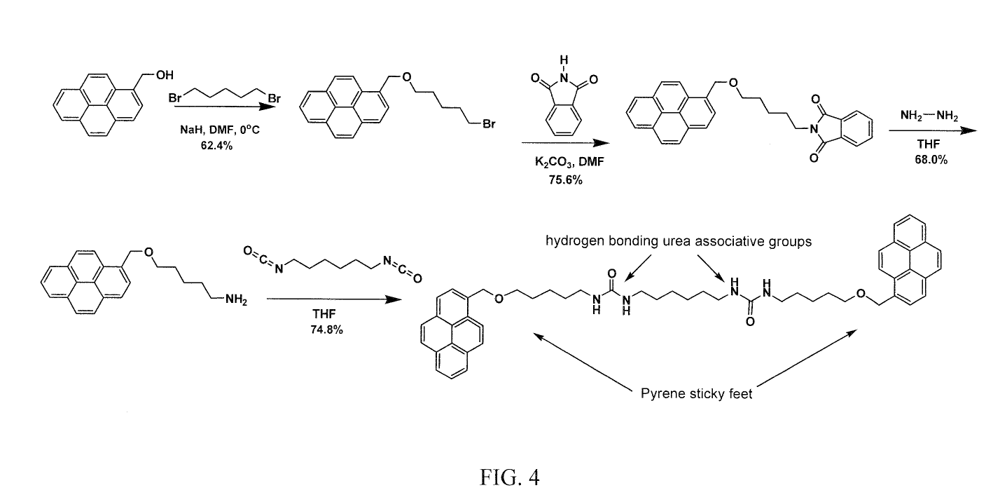

FIG. 4 illustrates the synthesis of a supramolecular polymer precursor that spontaneously associates reversibly into a supramolecular polymer by the hydrogen bonding between the urea associative groups. The pyrene sticky feet also appear to self associate. Precursors free of sticky feet also spontaneously associate reversibly into supramolecular polymers but do not have the additional polymer stability by the sticky feet and can be used as plasticizing co-precursors for the augmentation of suparamolecular polymers with sticky feet attached to a portion of the precursors. Tables 1 and 2, below give the structures of various sticky feet and plasticizing precursors that can be combined in various proportions to give the supramolecular polymers of the invention. The syntheses of some of these polymers are given below.

TABLE 1
Sticky feet supramolecular polymer precursors

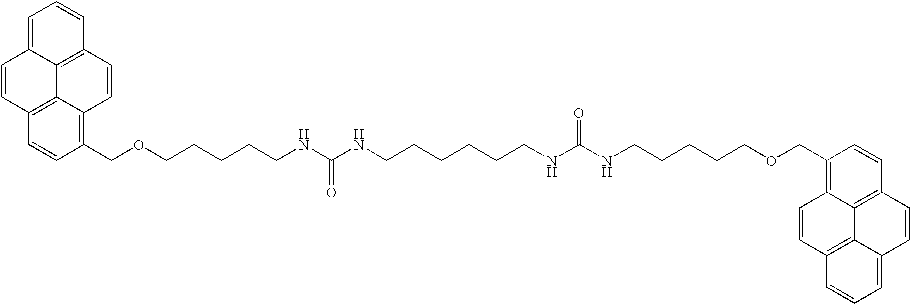

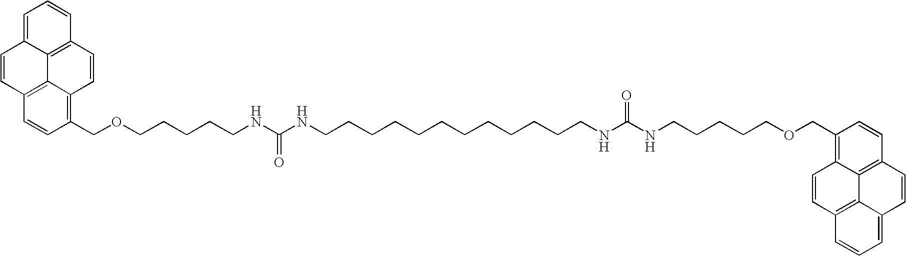

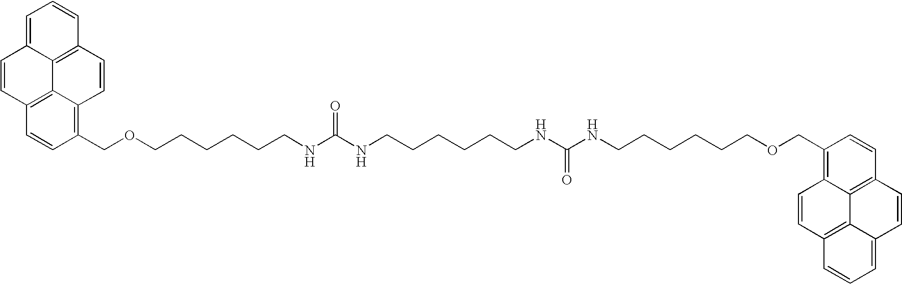

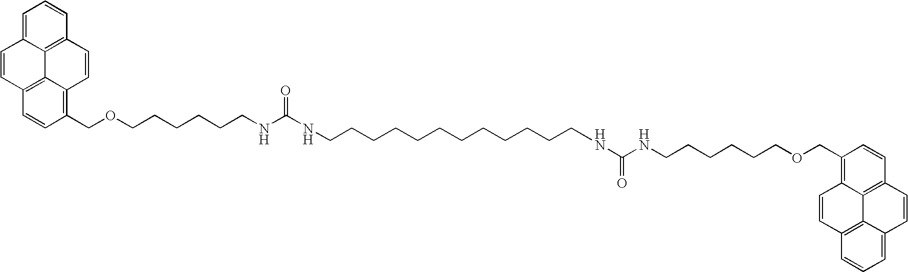

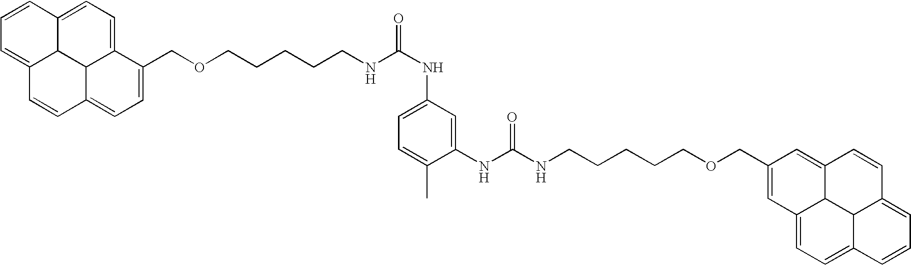

TABLE 2
Plasticizing supramolecular polymer precursors

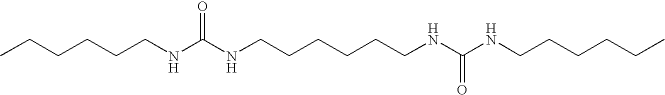

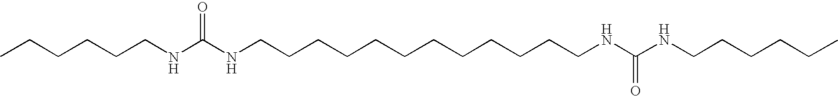

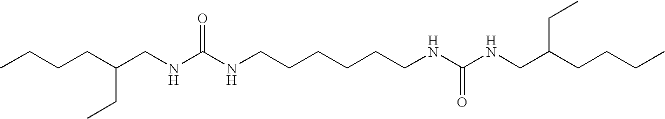

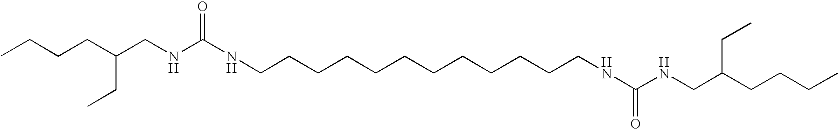

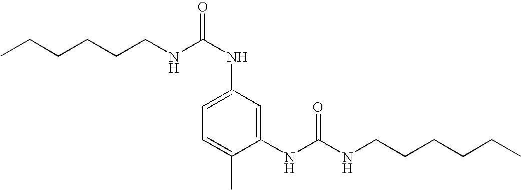

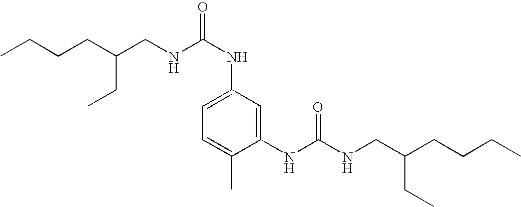

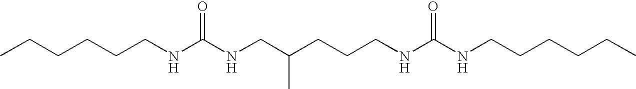

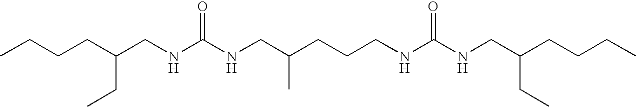

### 1-((5-bromopentyloxy)methyl)pyrene

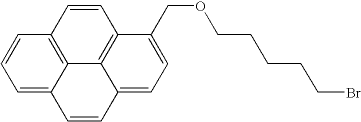

Into a 250 mL round-bottomed flask (RBF) equipped with a stir bar and blanketed with an argon atmosphere, was placed 1-pyrenemethanol (3.50 g, 15.06 mmol), dimethylformamide (DMF) (60 mL, anhydrous), and 1,5-dibromopentane (14.36 mL, 105.48 mmol). This solution was cooled to 0° C. via an ice bath, after which was added NaH (1.5 g, 37.67 mmol, 60% weight suspension in oil). The reaction mixture was stirred at 0° C. for 3 hours. Upon completion, the contents of the flask were poured into an ice water slurry (500 mL) and vigorously stirred for 10 minutes. The slurry was subsequently extracted with dichloromethane (DCM) (2×100 mL), washed with water (2×100 mL), washed with brine (100 mL), dried over sodium sulfate, and rotary evaporated to a crude solid. Excess 1,5-dibromopentane was distilled from the crude solid, and the solid was purified by flash column chromatography in 6:1 Hexanes:Ether. The reaction yielded 3.58 grams of a white, needle-like solid (62.4%).

### 2-(5-(pyren-1-ylmethoxy)pentyl)isoindoline-1,3-dione

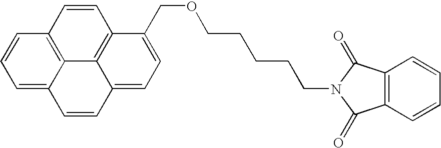

Into a 100 mL RBF equipped with a stir bar and blanketed with an argon atmosphere was placed 1-((5-bromopentyloxy)methyl)pyrene (3.38 g, 8.86 mmol), phthalimide (2.61 g, 17.74 mmol), DMF (50 mL) and potassium carbonate (3.06 g, 22.16 mmol). The reaction mixture was stirred for several hours; after which, 2 additional equivalents of potassium carbonate were added to the flask to help push the reaction to completion. The reaction mixture was stirred overnight. Upon completion, the contents of the flask were poured into an ice water slurry and stirred for 10 minutes. The solution was then extracted with DCM (2×150 mL), dried over sodium sulfate, and rotovaped down to a crude yellow solid; HCl (1M, 100 mL) and brine (100 mL) were added to the separatory funnel during each extraction to help break up extremely dense emulsions. This solid was then dissolved in a minimum amount of tetrahydrofuran (THF), poured into methanol (1.5 L), precipitated from solution upon addition of water, and filtered using a Buchner funnel. The reaction yielded 3.02 g of a yellowish, powder-like solid (76%).

### 2-(6-(pyren-1-ylmethoxy)hexyl)isoindoline-1,3-dione

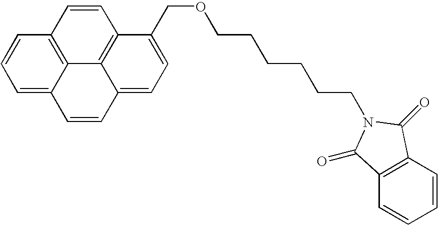

Into a 100 mL RBF equipped with a stir bar and blanketed with an argon atmosphere, was placed 1-((6-bromohexyloxy)methyl)pyrene (1.12 g, 2.83 mmol), DMF (50 mL), phthalimide (0.83 g, 5.67 mmol), and potassium carbonate (0.97 g, 7.08 mmol). After several hours, 2 additional equivalents of phthalimide and 2.5 additional equivalents of potassium carbonate were added to the flask, and the reaction mixture was stirred overnight. The contents of the flask were poured into an ice water slurry (500 mL) and stirred for several minutes. This solution was extracted with DCM and with HCl (1M, 100 mL) and brine (100 mL) added to the separatory funnel during each extraction to break up emulsions. Rotary evaporation of the DCM solution yielded a crude solid. This solid was extracted with DCM (2×150 mL) and the solution dried over sodium sulfate followed by rotary evaporation to a yellow solid. This solid was then dissolved in a minimum amount of THF, poured into methanol (1.5 L), precipitated upon the addition of water, and filtered over a Buchner funnel. The reaction yielded 1.12 g of a yellowish, powder-like solid (85.5%).

### 5-(pyren-1-ylmethoxy)pentan-1-amine

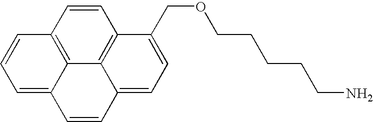

Into a 100 mL RBF equipped with a stir bar and blanketed with an argon atmosphere was placed, 2-(5-(pyren-1-ylmethoxy)pentyl)isoindoline-1,3-dione (2.80 g, 6.26 mmol), THF (60 mL), and hydrazine monohydrate (0.61 mL, 12.51 mmol). The reaction was heated to reflux and was monitored periodically via thin layer chromatography (TLC). After 4 hours, 1 additional equivalent of hydrazine monohydrate was added to the reaction mixture. The reaction was stirred for 2 additional hours, upon which 1 additional equivalent of hydrazine monohydrate was added to the reaction mixture. The reaction was stirred overnight. The contents of the flask were poured into NaOH (1M, 100 mL), extracted with DCM (2×50 mL), dried over sodium sulfate and rotary evaporated to a crude solid. This solid was dissolved in the minimum amount of MeOH, precipitated into HCl (3M), and filtered in a buchner funnel. The solids were washed with DCM and H₂O. A slurry was made from the collected solids and toluene (150 mL). While stirring, concentrated NaOH was then added to this slurry until all solids dissolved. The toluene layer was separated from the H₂O layer, dried over sodium sulfate, and rotary evaporated to a solid. The reaction yielded 1.57 g of a white powder-like solid (79%).

### 6-(pyren-1-ylmethoxy)hexan-1-amine

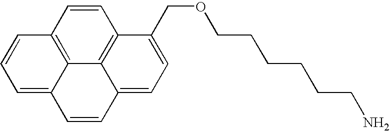

Into a 100 mL RBF equipped with a stir bar and blanketed with an argon atmosphere was placed, 2-(6-(pyren-1-ylmethoxy)hexyl)isoindoline-1,3-dione (1.00 g, 2.16 mmol), THF (50 mL), and hydrazine monohydrate (0.21 mL, 4.33 mmol). The reaction was heated to reflux and monitored periodically via TLC. After 4 hours, 1 additional equivalent of hydrazine monohydrate was added to the reaction mixture. The reaction was stirred for 2 additional hours, upon which 1 additional equivalent of hydrazine monohydrate was added to the reaction mixture. The reaction was stirred overnight. The contents of the flask were poured into NaOH (1M, 100 mL), extracted with DCM (2×50 mL), dried over sodium sulfate and rotary evaporated to a crude solid. The solid was dissolved in a minimum amount of MeOH, precipitated in HCl (3M), and filtered using a buchner funnel. The solids were washed with DCM and H₂O. A slurry of the washed solids in toluene (150 mL) was prepared. With stirring, concentrated NaOH was then added to this slurry until all solids dissolved. The toluene layer was separated from the H₂O layer, dried over sodium sulfate, and rotary evaporated. The reaction yielded 0.51 g of a white powder-like solid (71%).

### 1,1′-(hexane-1,6-diyl)bis(3-(5-(pyren-1-ylmethoxy)pentyl)urea)

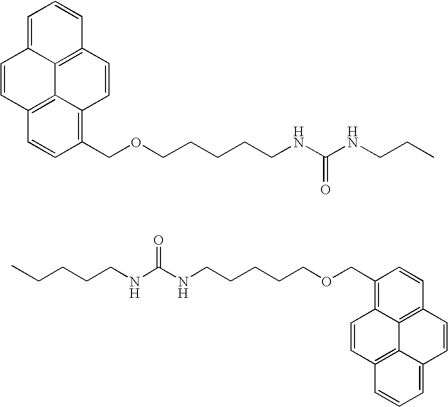

Into a dry 50 mL RBF equipped with a stir bar and blanketed with an argon atmosphere was placed 5-(pyren-1-ylmethoxy)pentan-1-amine (0.500 g, 1.58 mmol), o-dichlorbenzene (25 mL, distilled from CaH), and 1,6-diisocyanatohexane (0.116 mL, 0.716 mmol) respectively. Within 1 minute of the addition of 1,6-Diisocyanatohexane, the reaction medium changed from a low viscosity liquid into an extremely viscous gel. The reaction was then warmed until this gel dissolved, stirred for an additional 10 minutes, and then cooled back into a gel. The Gelatinous mixture was precipitated into THF (500 mL), filtered over a Buchner funnel to collect solids, and washed with THF. The reaction yielded 0.563 g of a white solid (97.9%) supramolecular polymer.

### 1,1′-(dodecane-1,12-diyl)bis(3-(5-(pyren-1-ylmethoxy)pentyl)urea)

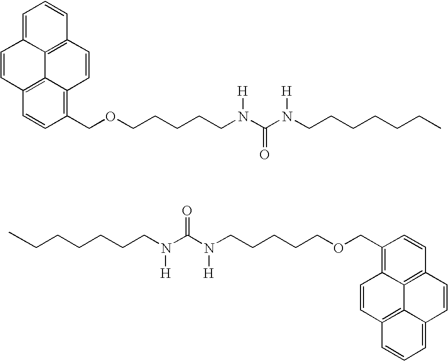

Into a dry 50 mL RBF equipped with a stir bar and blanketed with an argon atmosphere was placed 5-(pyren-1-ylmethoxy)pentan-1-amine (0.500 g, 1.58 mmol), o-dichlorbenzene (25 mL, distilled from CaH), and 1,12-diisocyanatododecane (0.192 mL, 0.716 mmol). Within 1 minute of the addition of 1,12-Diisocyanatododecane, the reaction medium changed from a low viscosity liquid into an extremely viscous gel. The reaction was warmed until this gel dissolved, stirred for an additional 10 minutes, and then cooled back into a supramolecular polymer. The gelatinous mixture was precipitated into THF (500 mL), filtered over a Buchner funnel to collect the solid supramolecular polymer, and washed with THF. The reaction yielded 0.475 g of a white solid supramolecular polymer (74.8%).

### 1,1′-(hexane-1,6-diyl)bis(3-(6-(pyren-1-ylmethoxy)hexyl)urea)

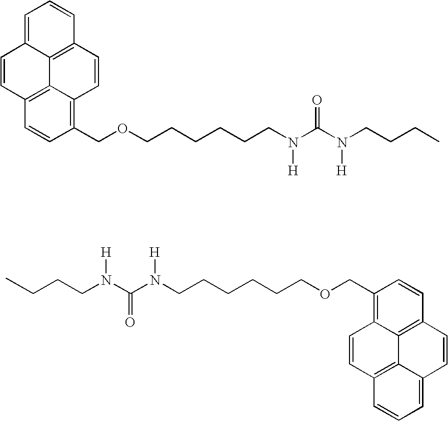

Into a dry 50 mL RBF equipped with a stir bar and blanketed with an argon atmosphere was placed 6-(pyren-1-ylmethoxy)hexan-1-amine (0.200 g, 0.603 mmol), o-dichlorbenzene (25 mL, distilled from CaH), and 1,6-diisocyanatohexane (0.0443 mL, 0.274 mmol). Within 1 minute of the addition of 1,6-Diisocyanatohexane, the reaction medium changed from a low viscosity liquid into an extremely viscous gel. The reaction mixture was warmed until this gel dissolved, allowed to stir for an additional 10 minutes, and then cooled back into a gel again. The gelatinous mixture was precipitated into THF (500 mL), filtered over a Buchner funnel to collect solid supramolecular polymer, and washed with THF. The reaction yielded 0.174 g of a white solid supramolecular polymer (76.3%).

### 1,1′-(dodecane-1,12-diyl)bis(3-(6-(pyren-1-ylmethoxy)hexyl)urea)

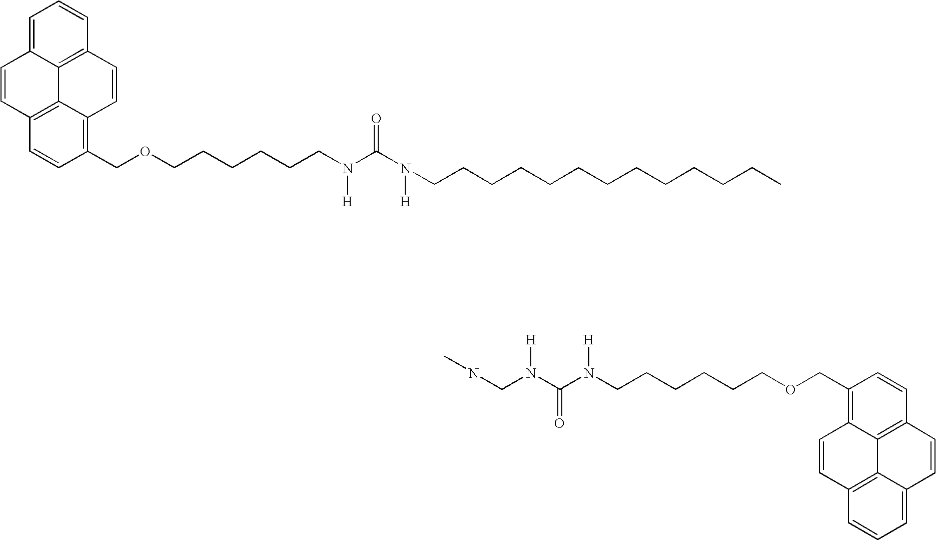

Into a dry 50 mL RBF equipped with a stir bar and blanketed with an argon atmosphere was placed 6-(pyren-1-ylmethoxy)hexan-1-amine (0.200 g, 0.603 mmol), o-dichlorbenzene (25 mL, distilled from CaH), and 1,12-diisocyanatododecane (0.0443 mL, 0.274 mmol). Within 1 minute of the addition of 1,12-diisocyanatododecane, the reaction medium changed from a low viscosity liquid into an extremely viscous gel. The reaction was warmed until this gel dissolved, stirred for an additional 10 minutes, and cooled back into a gel. The Gelatinous mixture was precipitated into THF (500 mL), filtered over a Buchner funnel to collect solid supramolecular polymer, and washed with THF. The reaction yielded 0.196 g of a white solid supramolecular polymer (78.1%).

### 1,1′-(hexane-1,6-diyl)bis(3-hexylurea)

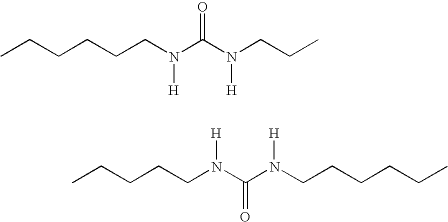

Into a dry 50 mL RBF equipped with a stir bar and outfitted with an argon atmosphere was placed hexylamine (2.61 mL, 19.73 mmol), o-dichlorbenzene (25 mL, distilled from CaH), and 1,6-diisocyanatohexane (1.06 mL, 6.58 mmol). Within 1 minute of the addition of 1,6-diisocyanatohexane, the reaction medium changed from a low viscosity liquid into an extremely viscous gel. The reaction was warmed until the gel dissolved, stirred for an additional 10 minutes, and then cooled back into a gel. The gelatinous mixture was precipitated into THF (500 mL), filtered over a Buchner funnel to collect solid supramolecular polymer, which was washed with THF. The reaction yielded 2.18 g of a white solid supramolecular polymer (89%).

### 1,1′-(dodecane-1,12-diyl)bis(3-hexylurea)

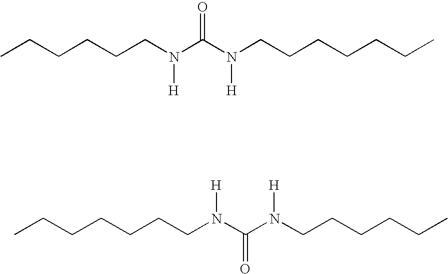

Into a dry 50 mL RBF equipped with a stir bar and blanketed with an argon atmosphere was placed hexylamine (2.94 mL, 22.23 mmol), o-dichlorbenzene (25 mL, distilled from CaH), and 1,6-diisocyanatododecane (1.99 mL, 7.41 mmol). Within 1 minute of the addition of 1,12-Diisocyanatododecane, the reaction medium changed from a low viscosity liquid into an extremely viscous gel. The reaction was then warmed until the gel dissolved, stirred for an additional 10 minutes, and then cooled back into a gel. The gelatinous mixture was precipitated into THF (500 mL), filtered using a Buchner funnel to collect solid supramolecular polymer, which was washed with THF. The reaction yielded 3.26 g of a white solid supramolecular polymer (97%).

### 1,1′-(hexane-1,6-diyl)bis(3-(2-ethylhexyl)urea)

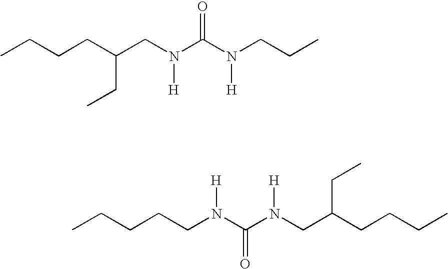

Into a dry 50 mL RBF equipped with a stir bar and blanketed with an argon atmosphere was placed 2-ethylhexylamine (2.53 mL, 15.46 mmol), o-dichlorbenzene (25 mL, distilled from CaH), and 1,6-diisocyanatohexane (0.83 mL, 5.15 mmol). Within 1 minute of the addition of 1,6-diisocyanatohexane, the reaction medium changed from a low viscosity liquid into an extremely viscous gel. The reaction was warmed until this gel dissolved, stirred for an additional 10 minutes, and then cooled back into a gel. The gelatinous mixture was precipitated into THF (500 mL), filtered using a Buchner funnel to collect solid supramolecular polymer, which was washed with THF. The reaction yielded 1.02 g of a white solid supramolecular polymer (47%).

### 1,1′-(dodecane-1,12-diyl)bis(3-(2-ethylhexyl)urea)

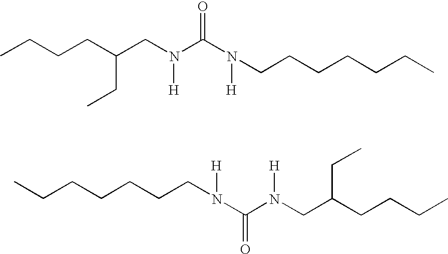

Into a dry 50 mL RBF equipped with a stir bar and blanketed with an argon atmosphere was placed 2-ethylhexylamine (2.53 mL, 15.46 mmol), o-dichlorbenzene (25 mL, distilled from CaH), and 1,12-diisocyanatododecane (1.38 mL, 5.15 mmol). Within 1 minute of the addition of 1,12-Diisocyanatododecane, the reaction medium changed from a low viscosity liquid into an extremely viscous gel. The reaction was warmed until the gel dissolved, stirred for an additional 10 minutes, and then cooled back into a gel. The gelatinous mixture was precipitated into THF (500 mL), filtered using a Buchner funnel to collect solid supramolecular polymer, and washed with THF. The reaction yielded 2.43 g of a white solid supramolecular polymer (92%).

All patents, patent applications, provisional applications, and publications referred to or cited herein, supra or infra, are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A sticky supramolecular polymer, comprising a multiplicity of associated precursors that in combination comprise:
a multiplicity of sticky feet having a structure for binding to a CNT surface, said sticky feet attached to at least some of said precursors through linkers;
a multiplicity of associative groups with at least one of said groups covalently bound to each of said precursors; and
at least one covalently connecting moiety connecting said associative groups to each other or to said linker in each of said precursors.

2. The polymer of claim 1, wherein said associative groups form self-association between two or more associative groups of a like structure.

3. The polymer of claim 1, wherein said associative groups form cross-association between two or more groups of complementary structures.

4. The polymer of claim 1, wherein said associative groups comprise hydrogen-bonding groups.

5. The polymer of claim 1, wherein said associative groups associate in the presence of a complexing agent.

6. The polymer of claim 5, wherein said associative groups comprise bidentate or polydentate ligands and said agent is a metal ion.

7. The polymer of claim 1, wherein said associative groups associate via at least one reversible covalent bond.

8. The polymer of claim 1, wherein said sticky feet independently comprise units that form non-covalent interactions with said CNT surfaces.

9. The polymer of claim 1, wherein at least some of said sticky feet comprise units that form donor-acceptor complexes with said CNT surfaces.

10. The polymer of claim 1, wherein at least some said connecting moiety comprises a plurality of non-conjugated repeat units.

11. The polymer of claim 1, wherein at least some of said connecting moiety comprises a plurality of conjugated repeat units.

12. The polymer of claim 1, wherein said linker comprises a flexible chain of 1 to 100 atoms.

13. The polymer of claim 1, wherein said linker comprises a flexible chain of 101 to 2000 atoms.

14. The polymer of claim 1, further comprising functionalities connected to said precursors wherein the functionalities modifies surface or bulk properties of said polymer.

15. The polymer of claim 14, wherein said functionalities comprise structures that undergoing irreversible reactions with each other or with other complementary reagents.

16. A CNT/supramolecular polymer composite, comprising:
a multiplicity of CNTs; and
a multiplicity of associated precursors that in combination comprise:
a multiplicity of sticky feet bound to said CNTs and are attached to at least some of said precursors through linkers;
a multiplicity of associative groups with at least one of said associative groups covalently bound to each of said precursor; and
at least one covalently connecting moiety connecting said associative groups to each other or to said linker in each of said precursors

17. The composite of claim 16, further comprising a multiplicity of functionalities that modifies bulk or surface properties of said composite.

18. The composite of claim 16, further comprising a multiplicity of irreversible cross-linking sites wherein said composite comprises essentially an irreversible network.

19. A method to form a CNT/supramolecular polymer composite comprising the steps of:
providing a multiplicity of CNTs;
providing a multiplicity of dissociated precursors that in combination comprise:
a multiplicity of sticky feet having a structure for binding to said CNTs attached to at least some of said precursors through a linker;
a multiplicity of dissociated associative groups with at least one of said associative groups covalently bound to each of said precursors; and
at least one connecting moiety covalently connecting said associative groups to each other or to said linker in each of said precursors;
dispersing said CNTs into said dissociated precursor; and
associating said dissociated precursor molecules containing said dispersed CNTs into said CNT/supramolecular polymer composite.

20. The method of claim 19, wherein said step of dispersing comprises mixing said CNTs with said precursors at a temperature greater than a critical temperature T_{c} for association of said associative groups and wherein said step of associating comprises cooling said mixture below T_{c}.

21. The method of claim 19, wherein said step of dispersing comprises mixing said CNTs with said precursors in a solvent wherein said solvent disrupts association of said associative groups and wherein said step of associating comprises removing said solvent.

22. The method of claim 19, wherein said step of dispersing comprises mixing said CNTs with said precursors wherein said associative groups are bonded to at least one protecting group and wherein said step of associating comprises removing said protecting groups.

23. The method of claim 19, wherein said step of dispersing comprises mixing said CNTs with said precursors wherein said associative groups require a complexing agent for association and wherein said step of associating comprises adding said complexing agent.

24. The method of claim 19, further comprising:
providing at least one functionality capable of undergoing an irreversible reaction attached to at least some of said precursors; and
promoting said irreversible reaction of said functionalities to form cross-linking sites.

25. The method of claim 24, further comprising:
providing at least one complementary reactive group of a structure that undergoes said irreversible reaction with said functionality, wherein said complementary reactive groups are in a monomeric, oligomeric or polymeric form separate of said precursors; and
wherein said cross-linking sites contain residues from said functionalities and said complementary reactive groups.
